(19) United States
(12) Patent Application Publication
(10) Pub. No.: US 2002/0023962 A1
(43) Pub. Date: Feb. 28, 2002

(54) CHIP CARD

(76) Inventor: DIRK FISCHER, PADERBORN (DE)

Correspondence Address: FOLEY & LARDNER, 3000 K STREET N W, SUITE 500, WASHINGTON, DC, 200075109

(21) Appl. No.: 09/136,451

(22) Filed: Aug. 19, 1998

(30) Foreign Application Priority Data
Aug. 20, 1997 (DE) 197 36 063.7

(51) Int. Cl. B29C 45/03; B29C 45/16; G06K 19/06

(52) U.S. Cl. 235/492; 264/255; 264/328.12; 264/328.19; 425/557

(57) ABSTRACT

The invention relates to a chip card with a card body that can be produced by injection-molding. The card body has a core component and an external component surrounding the core component. The external component has different material characteristics and/or a different color design than the core component.

### BACKGROUND OF THE INVENTION

This invention relates to a novel chip card and process for manufacturing chip cards. This invention also relates to a device that may be used in the process for manufacturing chip cards.

In conventional chip cards, such as those disclosed in EP 0 430 282 B1, several internal card layers, each consisting of a thermoplastic elastomer, are provided to achieve a flexible card structure. This layered structure permits higher stability of the chip card under a bending load. The disadvantage of these conventional chip cards is that the number of layers in each chip card, and the application of lamination technology to the chip cards, renders their production comparatively expensive.

Some conventional chip cards are manufactured by injection-molding of a single plastic material. The physical and chemical characteristics of the chip card are determined exclusively by the chosen plastic material.

### SUMMARY OF THE INVENTION

It is an object of the invention to provide a chip card, a process for manufacturing a chip card, and a device for use in the manufacture of a chip card, wherein the chip card has material characteristics that may be adjusted, depending on the chip card requirements. In addition, the chip card may be easily and safely manufactured.

A preferred embodiment of the invention which is intended to accomplish at least some of the foregoing objects includes a chip card having a core component and an external component surrounding the core component. Advantageously, the external and core components are comprised of materials that account for the different requirements for a core layer, on the one hand, and an outer cover or external layer, on the other hand. Such a chip card may be easily manufactured by injection-molding the chip card in a single manufacturing process.

In one embodiment of the invention, the external component has a thickness of 0.1 to 0.2 mm, so that the core component forms the largest volume of the chip card. The core component preferably is made of a recycled material, which thus can be reintroduced into the manufacturing process.

In another embodiment of the invention, the core component may be comprised of a thermoplastic elastomer, thus improving the card's elasticity or stability under a bending load.

The external and core components advantageously may consist of different materials, with the external component made of a visually attractive material and the core component made of a material exhibiting adequate material characteristics. Furthermore, a colorant may be added to the external component. This enables economically efficient production of the chip card.

The invention also contemplates a device for the implementation of a manufacturing process for chip cards. The devices enables easy and safe production of chip cards from several components.

The device, in accordance with the invention, allows injection of two components through one common nozzle in a single manufacturing step. The only adjustment parameter to be set is the ratio of volumes between the first and the second components.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a front elevation view, in cross section, of a chip card in accordance with a first embodiment of the invention;

FIG. 2 is a front elevation view, in cross section, of a chip card in accordance with a second embodiment of the invention;

FIG. 3 is a front elevation view, in cross section, of a chip card in accordance with a third embodiment of the invention; and

FIG. 4 is a schematic of a device for manufacturing chip cards in accordance with the invention.

### DETAILED DESCRIPTION OF THE PREFERRED EMBODIMENTS

The chip cards described below are manufactured by injection-molding using an injection molding machine. The machine is suitable for injecting several materials, preferably two, into a mold in sequence and/or almost simultaneously. The injection molding machine may be equipped with one nozzle, through which the materials are injected into the mold in sequence, or it may be equipped with two nozzles, one for each material, through which the two materials may be injected into the mold almost simultaneously. Preferably, an external component material enters the mold first and then, while cooling down, the external material is distributed over the wall of the mold when the core component is injected.

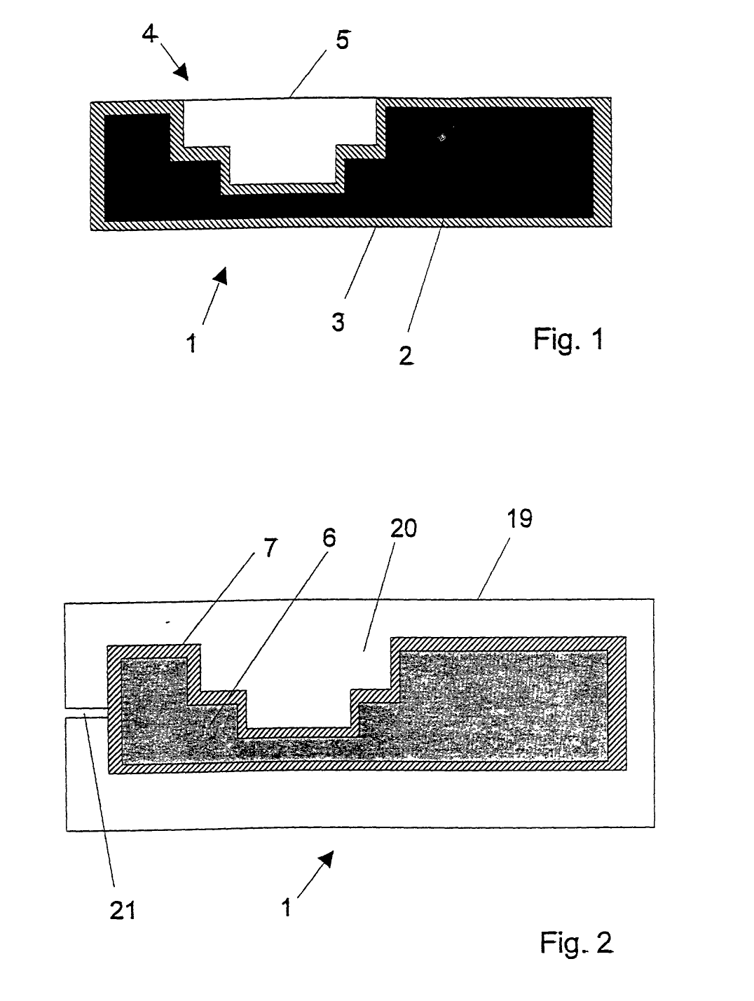

Referring now to the drawings, wherein like numerals indicate like parts, and initially to FIG. 1, there will be seen a chip card 1 according to a first embodiment of the invention. The chip card 1 includes a core component 2 and an external component 3. In this embodiment, the core component 2 comprises a recycled material, and the external component 3 comprises a prime material, such as a polycarbonate- (PC-) plastic material. The recycled material of the core component 2 may comprise ground stock or a shredded and/or regranulated, molten-down plastic material, such as acrylonitrile-butadiene-styrene (ABS), polycarbonate (PC), polytetrafluoroethylene (PET), or polyvinyl chloride (PVC). The core component 2 has a rather unattractive color as compared to the external component 3. The material characteristics of the recycled material may be identical with those of the material used for the external component 3.

The core component 2 is completely enclosed by the external component 3, so that the external component 3 surrounds and forms a protective layer about the core component 2. The external component 3 preferably takes up 20% of the card volume, so that the chip card 1 is securely protected against any mechanical or temperature load by the external component 3. The volume percentage of the external component 3 may, however, also be higher and reach up to approximately 40%. The bending characteristics of the chip card 1 are mainly determined by the material of core component 2.

The external component 3 includes a recess 4, into which a chip module 5 may be inserted and held in perfect bonding. The recess 4 can, on the one hand, be generated by milling after the injection process, or, on the other hand, it can be formed during the injection process by lowering a movable die.

According to a second embodiment of the invention shown in FIG. 2, a core component 6 comprises a thermoplastic elastomer (TPE), and an external component 7 comprises a high temperature resistant material, such as PC. This material combination increases the bending elasticity of the chip card 1. The chip card 1 is molded in mold 19, with a projection 20 in the mold, providing the recess required for subsequent insertion of a chip module. An injection point 21, through which the injection material is injected into mold 19, is situated approximately in the center of one side of the chip card 1.

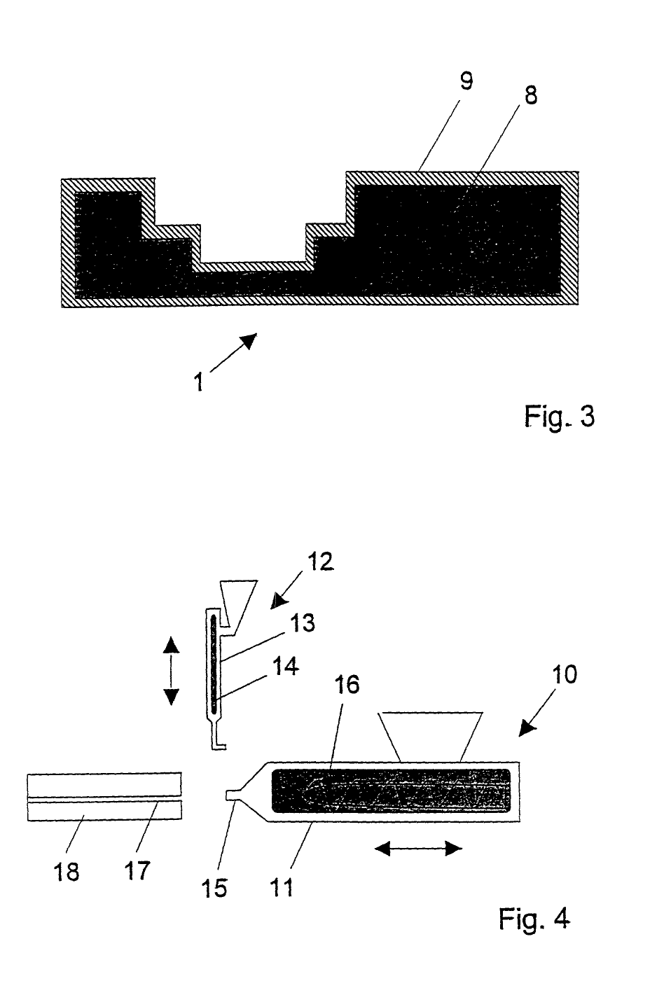

In a third embodiment of the invention as shown in FIG. 3, the chip card 1 includes a core component 8 comprising an ABS-material, and an external component 9 comprising a PC-material containing a color additive. Alternatively, the external component may comprise a polymethyl methacrylate- (PMMA-) material or a PFT- material. This allows any desired color design of the chip card 1.

FIG. 4 shows a device for injection-molding chip cards. The device includes an injection molding machine 10 having a main cylinder 11 and a subsidiary unit 12 having a subsidiary cylinder 13. Cylinders 11 and 13 are designed as melting cylinders. In the subsidiary cylinder 13, the external component 14 is molten. After the subsidiary unit 12 is moved into the nozzle area of main unit 10, this molten component 14 is channeled through main injection nozzle 15 of the injection molding machine 10 into the main cylinder 11. In main cylinder 11, the molten material of the external component 14 displaces the core component 16, which is already molten. In a subsequent injection process, the two components 14 and 16 are injected through main nozzle 15 into a mold space 17, which is formed by the mold 18. During this injection process, components 14 and 16, in molten form, are injected into the mold 18 at a consistent flow rate. The external component 14 gradually attaches itself to the walls of the mold 18 and cools. The core component 16 attaches itself gradually to the outer skin formed by the external component 14, thus filling the inner area of mold space 17. This manufacturing process is easy to operate, because only the quantitative ratio between the materials has to be determined. During the injection process, no switch-over between the delivery systems for the external and the core components need be performed. It should be noted that the external component material 14 and the core component material 16 must be chosen such that they are not combinable chemically with each other within a temperature range that includes the operating temperature of the injection process. This operating temperature range for the injection process will depend on the materials chosen.

As evident from FIG. 4, the auxiliary unit 12 may be moved in the direction of the up-down arrow, and the injection molding machine 10 may be moved in the direction of the side-to-side arrow.

Additional advantages and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims.

What is claimed is:

1. A chip card, comprising:
an injection-molded card body having a core component and an external component surrounding the core component, the external component having at least one of a different material characteristic and a different color design than the core component.

2. A chip card according to claim 1, wherein the external component has a thickness of 0.1 mm to 0.2 mm.

3. A chip card according to claim 1, wherein the core component comprises a recycled material, and the external component comprises a prime material.

4. A chip card according to claim 2, wherein the core component comprises a recycled material, and the external component comprises a prime material.

5. A chip card according to claim 1, wherein the core component comprises a thermoplastic elastomer (TPE), and the external component comprises a material resistant to high temperatures.

6. A chip card according to claim 2, wherein the core component comprises a thermoplastic elastomer (TPE), and the external component comprises a material resistant to high temperatures.

7. A chip card according to claim 1, wherein the external component comprises at least one of a PC-material or an ABS-material.

8. A chip card according to claim 2, wherein the external component comprises at least one of a PC-material or an ABS-material.

9. A chip card according to claim 3, wherein the external component comprises at least one of a PC-material or an ABS-material.

10. A chip card according to claim 5, wherein the external component comprises at least one of a PC-material or an ABS-material.

11. A chip card according to claim 1, wherein the core component comprises an ABS-material, and the external component comprises at least one of a PC-material, a PMMA-material and a PFT material.

12. A chip card according to claim 2, wherein the core component comprises an ABS-material, and the external component comprises at least one of a PC-material, a PMMA-material, and a PFT material.

13. A chip card according to claim 1, wherein at least one of the external component and the core component comprises a material having a colorant.

14. A chip card according to claim 2, wherein at least one of the external component and the core component comprises a material having a colorant.

15. A chip card according to claim 3, wherein at least one of the external component and the core component comprises a material having a colorant.

16. A chip card according to claim 5, wherein at least one of the external component and the core component comprises a material having a colorant.

17. A chip card according to claim 7, wherein at least one of the external component and the core component comprises a material having a colorant.

18. A chip card according to claim 11, wherein at least one of the external component and the core component comprises a material having a colorant.

19. A process for manufacturing a chip card, comprising the steps of:
injecting a first plastic material into a mold having a mold space to create an external component situated at an outer side of the mold space; and
injecting a second plastic material into the mold space to form a core component surrounded by the external component.

20. A process according to claim 19, wherein the injecting steps are performed through a single nozzle.

21. A process according to claim 19, further comprising the steps of:
prior to the injecting steps, introducing the first plastic material in molten form into a subsidiary unit; and
channeling the first plastic material from the subsidiary unit into a main unit containing the second plastic material in molten form.

22. A process according to claim 19, and further comprising the step of:
performing the injecting steps in a single injection step.

23. A process according to claim 19, wherein the step of injecting the second plastic material occurs before the first plastic material has hardened completely, the second plastic material continuously displacing the first plastic material towards an end of a flow path into the mold space so that the second plastic material forms an outer skin of the chip card.

24. A device for use in a process for manufacturing a chip card, comprising:
an injection molding machine having a main cylinder for holding a plastic material used to form a core component of the chip card, the main unit having a main injection nozzle; and
a subsidiary unit having a subsidiary cylinder for holding a plastic material used to form an external component of the chip card, the subsidiary unit having a feeding nozzle for engagement with the main injection nozzle of the main unit so that the plastic material used to form the external component may be fed into the main unit.

25. A device according to claim 24, wherein the subsidiary unit is positioned at a right angle to the injection molding machine, the subsidiary unit being moveable toward the injection molding machine so that the feeding nozzle may engage the main injection nozzle.

26. A device according to claim 24, wherein the subsidiary unit has a melting cylinder to melt the plastic material used to form the external component.
